(19) United States
(12) Patent Application Publication
(10) Pub. No.: US 2009/0256337 A1
(43) Pub. Date: Oct. 15, 2009

(54) SEAT BELT AIRBAG MODULE

(75) Inventor: James YU-MING PAN, TAIPEI CITY (TW)

Correspondence Address: Chih Feng Yeh;BRIAN M. MCINNIS, 12th Floor, Ruttonjee House, 11 Duddell Street, Hong Kong, HK

(73) Assignee: INNOBRAIN TECH. CO. LTD, TAIPEI CITY (TW)

(21) Appl. No.: 12/420,830

(22) Filed: Apr. 9, 2009

(30) Foreign Application Priority Data
Apr. 9, 2008 (TW) 97112900

(51) Int. Cl. B60R 21/18

(52) U.S. Cl. 280/733

(57) ABSTRACT

A seat belt airbag module, which is an independent device, comprises a pouch which is designed to attach the seat belt by sliding the seat belt through a seatbelt channel and secure it by a fastener; a connector to connect the pouch and an inflator; an inflator which is installed in the seat back and linked to the crash sensing system. This seat belt airbag module can be attached and fastened to the seat belt by a simple sliding action and set in front of an occupant's body. The inflatable airbag is designed to inflate upward and forward so as to offer a cushion effect against the crash impact yet eliminate the potential danger of punching right toward the occupant's body as conventional airbags do.

### RELATED APPLICATIONS

This application claims priority to Taiwan Application Serial Number 97112900, filed Apr. 9, 2008, which are herein incorporated by reference.

### BACKGROUND

1. Field of Invention

The present invention relates to an accident protect device for a transport vehicle. More particularly, the present invention relates to an airbag device.

2. Description of Related Art

An airbag module is installed within a car to prevent injuring of passenger or driver from a crash impact, but the airbag module still has several disadvantages. In particular, a conventional airbag is installed within a steering wheel or a dashboard panel with a fixed size no matter who (a child or an adult) sits on seat. In addition, the airbag is inflated in a direction against occupant's body, thereby often causes injury to the occupant's face, head or neck. A child, pregnant woman and someone wearing glasses are often injured when the airbag is inflated right toward them.

### SUMMARY

The main object of the present invention is to provide an air bag device that can be easily attached to the seat belt systems. By combining the advantages of airbag device and seat restraint systems, the seat belt airbag module assures the direction of airbag deployment forward and upward along the body movement of an occupant while impact happens. This design eliminates the possible fatalities caused by deploying the air bag right toward the occupant's face as conventional airbag devices do. By setting the air bag module at the same side with seat belt, the seat belt air bag module offers a safer cushion protection for occupants.

Another object of the present invention is to design a seat belt air bag device to be easily attachable to the existed two or three points seat belt systems in order to provide the benefit of both the air bag and seat belt systems onto every seat on vehicle.

A further object of the present invention is to integrate the design of seat belt air bag device into a four-point or five-point seat restraint to enhance the cushion protection for sports car or racing car occupants.

It is therefore an objective of the present invention to provide a seat belt airbag module to be detachably connected with seat belts of various types, thereby enabling the airbag to be inflated along a safer direction rather facing toward occupant's body.

In accordance with the foregoing and other objectives of the present invention, a seat belt airbag module includes a pouch, an inflator, a fastener, a sleeve and a seat belt channel. The pouch has an inflatable airbag inside thereof. The inflator contains compressed gas to inflate the airbag. The fastener is disposed at an end of the pouch. The sleeve extends from an opposite end of the pouch. The connection tube is disposed through the sleeve and interconnected between the airbag and the inflator. The seat belt channel, which is defined within the pouch and the sleeve, permits a seat belt to be there through, wherein the seat belt channel has two respective openings on the pouch and the sleeve.

In accordance with the foregoing and other objectives of the present invention, a seat belt airbag module includes a pouch, an inflator, a connection tube and a plurality of fasteners. The pouch has an inflatable airbag inside thereof. The inflator contains compressed gas to inflate the airbag. The connection tube is interconnected between the airbag and the inflator. The plurality of fasteners are disposed on the pouch to be detachably connected with a seat belt set.

In accordance with the foregoing and other objectives of the present invention, a seat belt airbag module includes a pouch, an inflator, a fastener and a seat belt channel. The pouch has an inflatable airbag inside thereof. The inflator is connected to the airbag through a connection tube. The fastener is disposed at an end of the pouch. The seat belt channel is disposed outside the pouch and permitting a seat belt to be there through.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 and FIG. 2 illustrate a front view and back view of a seat belt airbag module according to one preferred embodiment of this invention;

FIG. 3 illustrates a cross-sectional view of the pouch in FIG. 1;

FIG. 4 illustrates a cross-sectional view of a pouch according to another preferred embodiment of this invention;

FIG. 5 illustrates a seat belt airbag module implemented with a three-point seat belt;

FIG. 6 illustrates a front view of an inflated airbag in FIG. 5;

FIG. 7 illustrates a side view of an inflated airbag in FIG. 5;

FIG. 8 illustrates a seat belt airbag module implemented with a four-point seat belt;

FIG. 9 illustrates another seat belt airbag module implemented with a four-point seat belt; and

FIG. 10 illustrates a seat belt airbag module implemented with a five-point seat belt.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

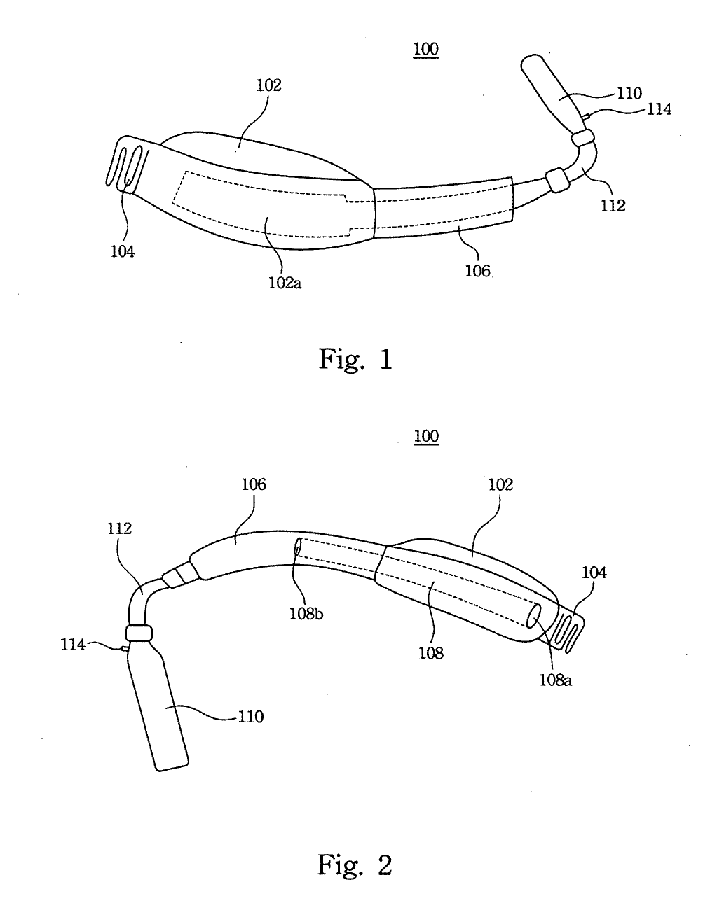

FIG. 1 and FIG. 2 respectively illustrate the front view and the back view of a seat belt airbag module according to one preferred embodiment of this invention. The seat belt airbag module 100 includes a pouch 102, a connection tube 112 and an inflator 110. The pouch 102 contains an inflatable airbag 102a. The pouch 102 has a fastener 104 at an end and a sleeve 106 extends from an opposite end of the pouch 102. Both the fastener 104 and the sleeve 106 are used to secure a seat belt. The fastener 104 permits a seat belt to be fed through its slits such that a length of the seat belt for securing a human body can be adjusted. A seat belt channel 108 is formed within the pouch 102 and the sleeve 106 that a seat belt can be disposed through the seat belt channel 108. The seat belt can be fed into or out the seat belt channel 108 through an opening 108a (on the pouch 102) or an opening 108b (on the sleeve 106). The inflatable airbag 102a extends through within the pouch 102 and the sleeve 106, and is connected to the inflator 110 by the connection tube 112. The inflator 110 contains compressed gas inside thereof and is equipped with an igniter 114, which is electrically connected to a vehicle's crash impact sensing system (not illustrated in drawings). When a car encounter an accident, which generates enough crash impact, the crash impact sensing system will initiate the igniter 114 to release the compressed gas from the inflator 110.

When the compressed gas within the inflator 110 is released, the airbag 102a is inflated through the connection tube 112 and the pouch 102 would be broken apart along a pre-set seam 102e. Thus, the airbag 102a would be inflated upward and forward relative to an occupant's body to generate a cushion effect to protect the occupant.

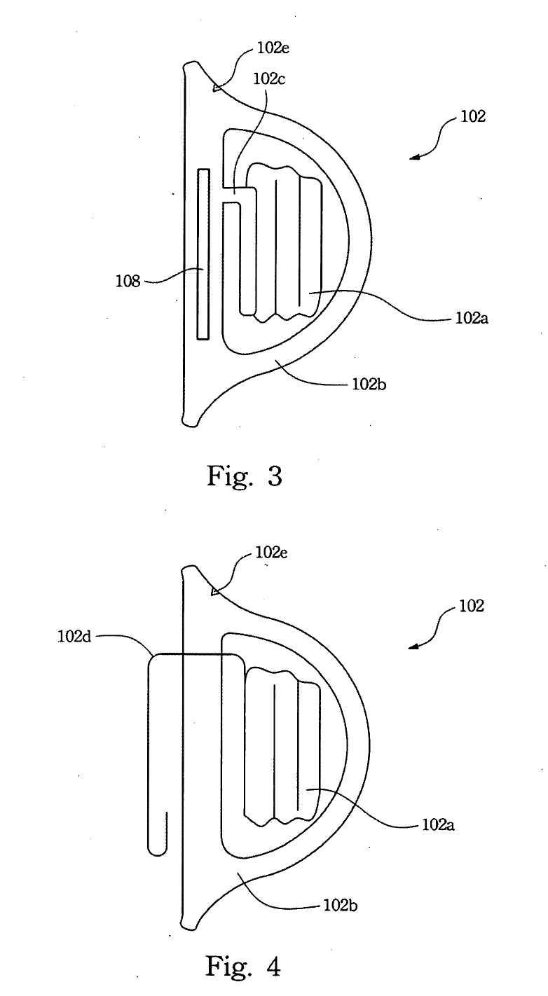

FIG. 3 illustrates a cross-sectional view of the pouch in FIG. 1. The pouch 102 contains a foldable airbag 102a. The airbag 102a is folded in such a way that the airbag 102a can be rapidly inflated. The airbag 102a is attached to a fastening frame 102c. When the compressed gas within the inflator 110 is released, the airbag 102a is inflated through the connection tube 112, breaks apart the pouch 102 along the pre-set seam 102e and is inflated bigger after the pouch 102 is broken apart.

FIG. 4 illustrates a cross-sectional view of a pouch according to another preferred embodiment of this invention. The pouch 102 may be designed in a way different from the embodiment illustrated in FIG. 3. A fastening frame 102d penetrates through a pouch wall 102b. Part of the fastening frame 102d is inside the pouch 102 to be attached by the airbag 102a while part of the fastening frame 102d is outside the pouch 102 and bent as a seat belt channel (providing similar function as the seat belt channel 108) to allow a seat belt to be there through.

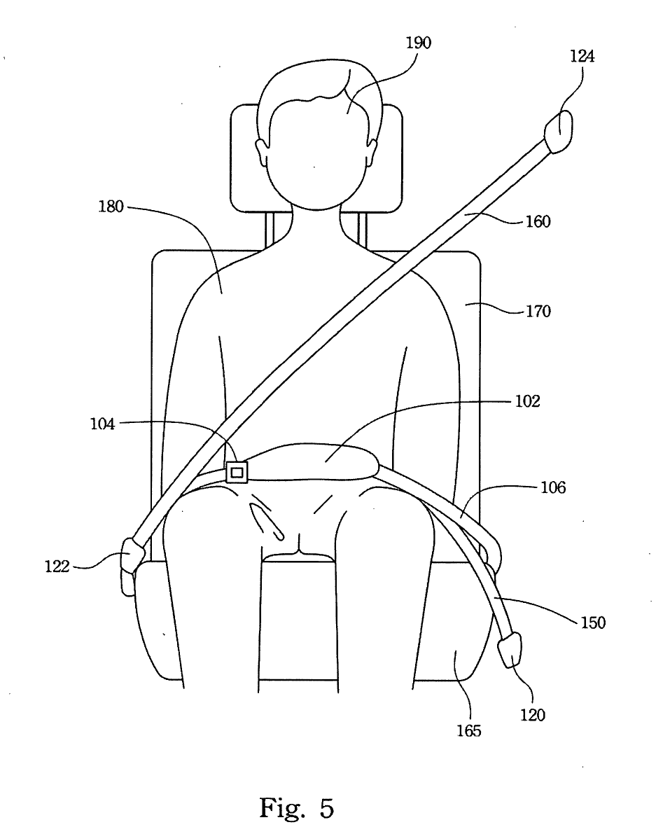

FIG. 5 illustrates a seat belt airbag module implemented with a three-point seat belt. When the seat belt airbag module 100 is implemented, the inflator 110 and the connection tube 112 are secured within a chair back or a chair cushion pad. The igniter 114 is electrically connected to a vehicle's crash impact sensing system. The seat belt airbag module 100 has its pouch 102 and sleeve 106 attached to a seat belt 150, which is fed through the seat belt channel 108 (as illustrated in FIG. 2). The pouch 102 is also equipped with the fastener 104 to be detachably connected with the seat belt 150. The seat belts 150 and 160 are secured by three fixed ends 120, 122 and 124 such that the seat belt airbag module 100 can be properly implemented with a three-point seat belt.

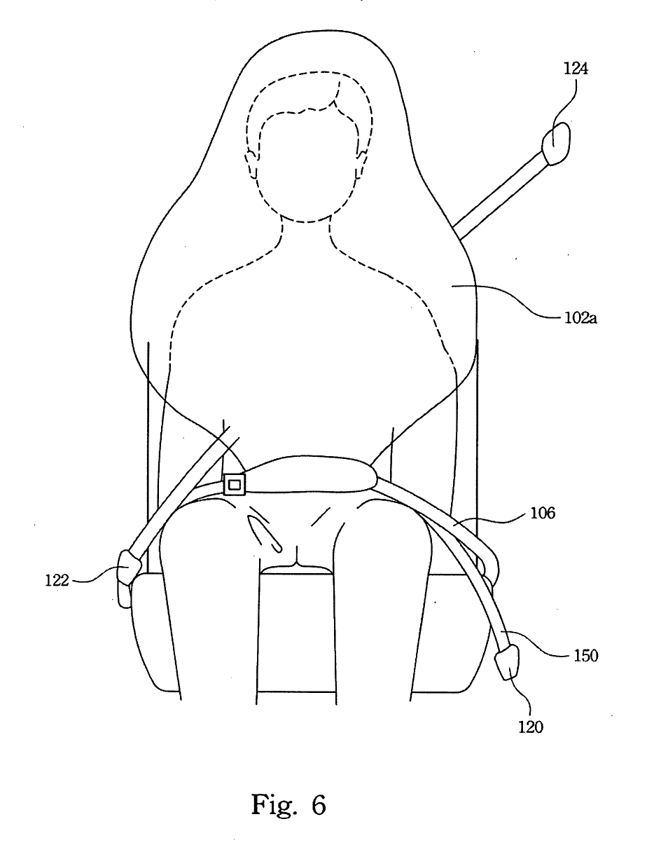

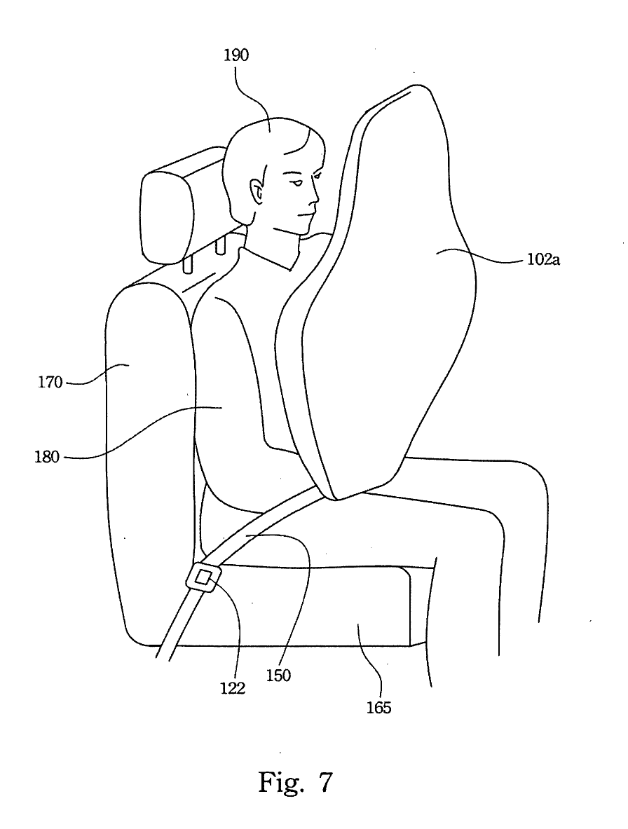

FIG. 6 illustrates a front view of an inflated airbag in FIG. 5 while FIG. 7 illustrates a side view of an inflated airbag in FIG. 5. The inflated airbag 102a is in front of an occupant's body 180 such that the occupant's body 180 is sandwiched and protected between the airbag 102a and the chair back 170. The airbag 102a is generally of a rhombus shape to suit for a human body's shape when the airbag 102a is fully inflated. The middle, wider part of the airbag 102a can be used to better protect the human body 180.

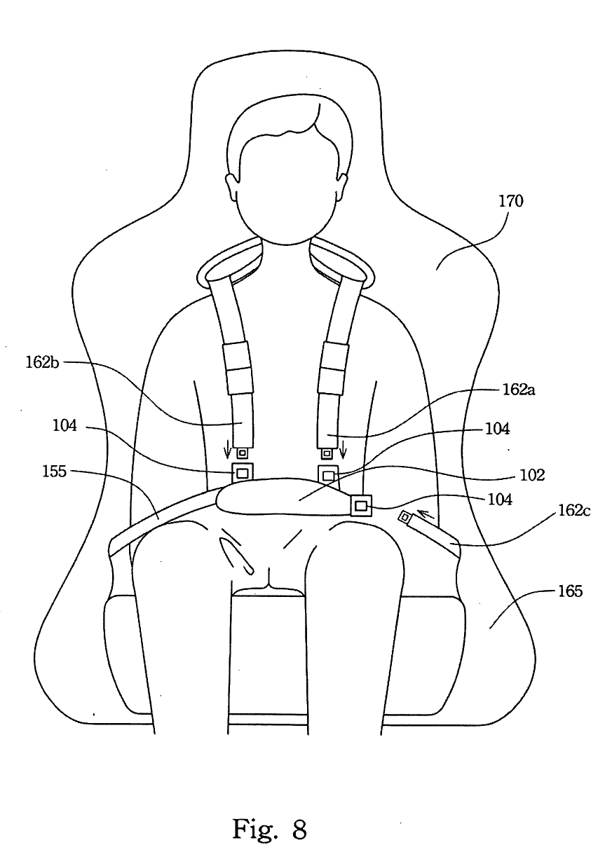

FIG. 8 illustrates a seat belt airbag module implemented with a four-point seat belt. When the seat belt airbag module 100 is implemented, the inflator 110 and the connection tube 112 are secured within a chair back or a chair cushion pad. The igniter 114 is electrically connected to a vehicle's crash impact sensing system. The seat belt airbag module 100 has its pouch 102 attached to a seat belt 155, which is fed through the seat belt channel 108 (as illustrated in FIG. 2). The pouch 102 is also equipped with three fasteners 104 to be detachably connected with the seat belts 162a, 162b, and 162c such that the pouch 102 is located around the occupant's waist or belly. When the airbag 102a is fully inflated, the status is in a similar condition as illustrated in FIG. 6 and FIG. 7.

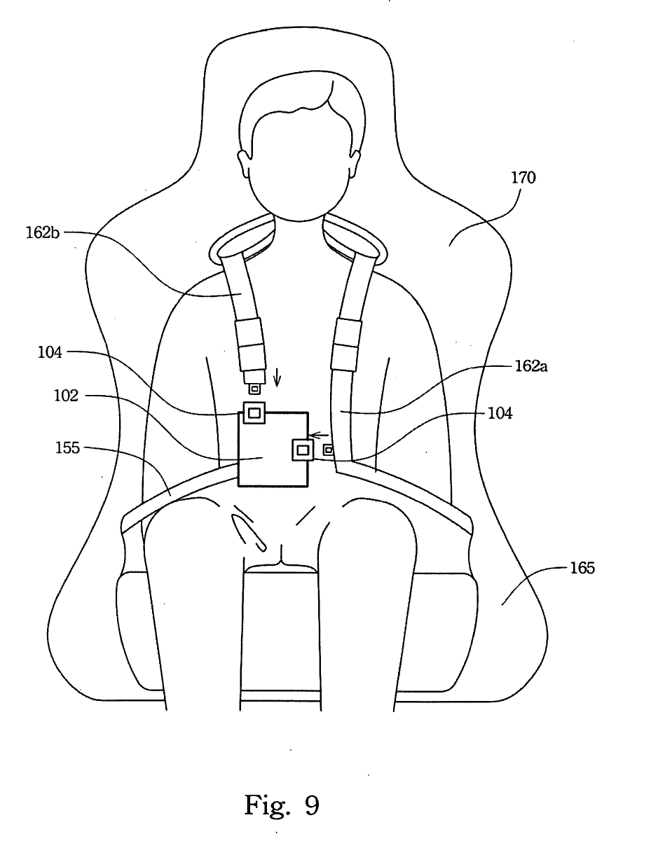

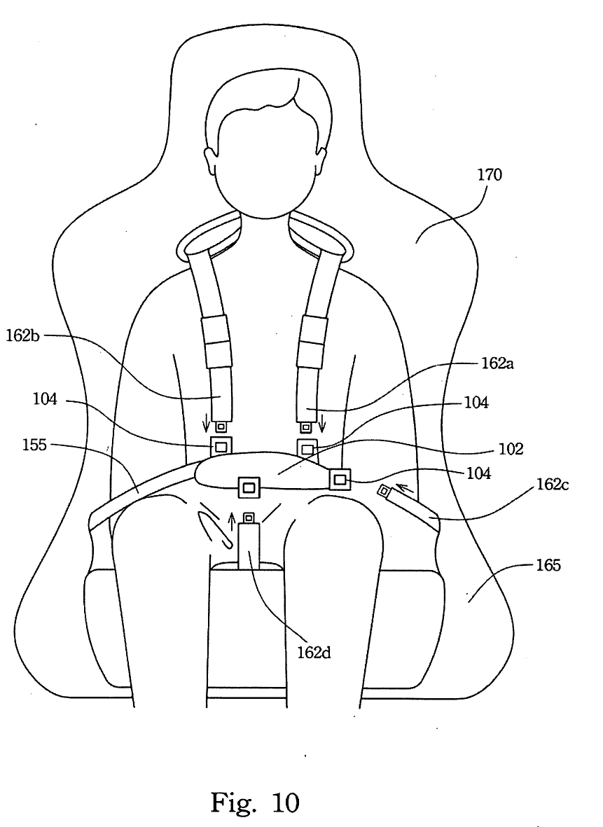

FIG. 9 illustrates another seat belt airbag module implemented with a four-point seat belt. The seat belt airbag module 100 has its pouch 102 attached to a seat belt 155, which is fed through the seat belt channel 108 (as illustrated in FIG. 2). The pouch 102 is also equipped with two fasteners 104 to be detachably connected with the seat belts 162a, 162b such that the pouch 102 is located around an occupant's waist or belly. When the airbag 102a is fully inflated, the status is in a similar condition as illustrated in FIG. 6 and FIG. 7.

FIG. 10 illustrates a seat belt airbag module implemented with a five-point seat belt. The seat belt airbag module 100 has its pouch 102 attached to a seat belt 155, which is fed through the seat belt channel 108 (as illustrated in FIG. 2). The pouch 102 is also equipped with four fasteners 104 to be detachably connected with the seat belts 162a, 162b, 162c and 162d such that the pouch 102 is located around an occupant's waist or belly. When the airbag 102a is fully inflated, the status is in a similar condition as illustrated in FIG. 6 and FIG. 7.

According to discussed embodiments, the seat belt airbag module is an independent device, which is detachably connected with a seat belt of different types. The seat belt airbag module is easily replaceable such that customers can choose a seat belt airbag module of suitable sizes, demands and types. Besides, the pouch with an airbag inside is located around an occupant's waist or belly, thereby enabling the airbag to be inflated along a safer direction, rather than a direction right toward the occupant's body. The seat belt airbag module can be easily implemented on any seat of a vehicle as long as the seat is equipped with a seat belt.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A seat belt airbag module, comprising:
a pouch having an inflatable airbag inside thereof;
an inflator containing compressed gas to inflate the airbag;
a fastener disposed at an end of the pouch;
a sleeve extending from an opposite end of the pouch;
a connection tube disposed through the sleeve and interconnected between the airbag and the inflator; and
a seat belt channel, defined within the pouch and the sleeve, permitting a seat belt to be there through, wherein the seat belt channel has two respective openings on the pouch and the sleeve.

2. The seat belt airbag module of claim 1, wherein the pouch comprises a fastening frame to permit the airbag to be attached thereon.

3. The seat belt airbag module of claim 1, wherein the airbag is generally of a rhombus shape when the airbag is fully inflated.

4. A seat belt airbag module, comprising:
a pouch having an inflatable airbag inside thereof;
an inflator containing compressed gas to inflate the airbag;
a connection tube interconnected between the airbag and the inflator; and
a plurality of fasteners disposed on the pouch to be detachably connected with a seat belt set.

5. The seat belt airbag module of claim 4, wherein a quantity of the fasteners is three, and the fasteners are detachably connected with a four-point seat belt.

6. The seat belt airbag module of claim 4, wherein a quantity of the fasteners is four, and the fasteners are detachably connected with a five-point seat belt.

7. The seat belt airbag module of claim 4, wherein a quantity of the fasteners is two, and the fasteners are detachably connected with a four-point seat belt.

8. The seat belt airbag module of claim 4, further comprising a sleeve extending from an end of the pouch.

9. The seat belt airbag module of claim 8, wherein the connection tube is disposed through the sleeve.

10. The seat belt airbag module of claim 4, wherein the pouch comprises a fastening frame to permit the airbag to be attached thereon.

11. The seat belt airbag module of claim 4, wherein the airbag is generally of a rhombus shape when the airbag is fully inflated.

12. A seat belt airbag module, comprising:
a pouch having an inflatable airbag inside thereof;
an inflator being connected to the airbag through a connection tube;
a fastener disposed at an end of the pouch; and
a seat belt channel disposed outside the pouch and permitting a seat belt to be there through.

13. The seat belt airbag module of claim 12, wherein the airbag is generally of a rhombus shape when the airbag is fully inflated.

14. The seat belt airbag module of claim 12, wherein the pouch comprises a fastening frame to permit the airbag to be attached thereon, the fastening frame protrudes out of the pouch and bends to define the seat belt channel.
